(19) United States
(12) Patent Application Publication
(10) Pub. No.: US 2004/0032121 A1
(43) Pub. Date: Feb. 19, 2004

(54) Motor vehicle steering column unit with adjustable steering column

(76) Inventors: Burkhard Schafer, Ganderkesee (DE); Kay-Uwe Grams, Cappeln (DE); Herniu Michalski, Brinkum (DE); Gunther Horsak, Meckenbeuren (DE); Lutz Muller, Herdwangen (DE)

Correspondence Address: McGlew and Tuttle, Scarborough Station, Scarborough, NY, 10510-0827, US

(21) Appl. No.: 10/416,626

(22) PCT Filed: Sep. 10, 2002
(86) PCT No.: PCT/DE02/03366

(30) Foreign Application Priority Data
Sep. 10, 2001 (DE) DE101 44 476.1

(51) Int. Cl. B62D 1/18

(52) U.S. Cl. 280/775

(57) ABSTRACT

The invention relates to a motor vehicle steering column unit consisting of a steering column which can be electromechanically adjusted in the longitudinal direction of and/or in relation to the inclination thereof. The aim of the invention is to provide a steering column unit which can be easily adapted to various types of vehicles and which can be configured, during the manufacturing process thereof, in a variety of manners with respect to the functionality thereof, said steering column unit being clearly defined systemically in relation to other components of the motor vehicle. The inventive motor vehicle steering unit is thus provided with at least one drive unit, one electronic control unit for generating control signals for the drive(s) and electric actuators in addition to connections enabling the unit to be connected to the vehicle electric system, as well as the necessary mechanical elements and actuators for actuation of the steering and electrically induced modification of the position of the steering column.

### SPECIFICATION

The present invention pertains to a motor vehicle steering column unit with a steering column electromechanically adjustable in the longitudinal direction and/or in terms of its tilt.

To increase the safety and the comfort, motor vehicles now usually have many different possibilities of adapting parts of the interior fittings as well as operating and safety elements to the differences in the physiognomy of their drivers. In addition, many of the above-mentioned components are supplied by outside vendors as complete assembly units to the vehicle manufacturers, and outside vendors who supply different vehicle manufacturers seek to design the assembly units for economical reasons such that they can be simply and flexibly adapted to the use in different vehicle models.

It has been known for a rather long time that the steering column of a motor vehicle can be made adjustable. The position of the steering column can be changed corresponding to the driver's wishes by a longitudinal displacement and/or by changing its tilt. In more expensive automobiles and in more modern vehicle designs, the adjustment of the steering column is carried out electromechanically by means of one or more drives. One example of a steering column unit designed in this manner is described in DE 196 41 152 A1. The adjustment of the steering column is carried out, as is also known from other solutions, by means of an adjusting spindle actuated by a drive and one or two spindle nuts that run on the spindle and are mounted movably in the axial direction of the spindle. In the solution shown, it is achieved by the use of electromechanical switching mechanisms that the same spindle is used for both the longitudinal displacement of the steering column and for changing its tilt angle. Unlike in other solutions, only one drive is required as a result. The drive is controlled by a computer unit, usually a central computer of the vehicle in question, which is to be connected to the steering column unit during the installation of the steering column unit in a motor vehicle. However, a certain drawback of this design can be seen precisely here. It can be considered to be disadvantageous here from the viewpoint of production organization concerning the outside vendor-vehicle manufacturer relationship that the systems are not clearly demarcated due to the connection of the steering column unit to a computer unit of the motor vehicle, which connection is necessary to make possible the adjustability. However, such a demarcation of the systems is desirable especially for reasons of warrantee. Moreover, the possibilities of the functions that can be embodied on the steering column are predetermined and partially also limited by the functionality and the storage capacity of the vehicle electronics system, which is an external system in relation to the steering column unit.

The object of the present invention is to provide a motor vehicle steering column unit, which can be adapted to different vehicle models in a simple manner and can be variably configured concerning its functionality already in the manufacturing process and in which the system is clearly demarcated against other assembly units of the motor vehicle.

This object is accomplished by a motor vehicle steering column with the features in the principal claim. Advantageous embodiments and variants are described in the subclaims.

The motor vehicle steering column unit, whose steering column is electromechanically adjustable in the longitudinal direction and/or concerning its tilt angle in the known manner, comprises, besides the mechanical elements and final control elements necessary for the actuation of the steering as well as for the electrically initiated changing of the position of the steering column, at least a drive, an electronic control unit for generating control signals for the drive or drives and electrical final control elements as well as terminals for connecting the unit to the onboard power supply system. The mechanical elements are levers, bearings and the like as well as preferably one or more adjusting spindles, on which axially displaceably mounted spindle nuts run during their rotation and move the steering column assembly directly or indirectly during their movement on the spindle via other elements connected to them. The spindles are set into rotary movement by the drive via coupling elements or a gear mechanism. Unlike in the state of the art, the control unit necessary for the electric final control elements present for actuating the drive or drives as well as optionally additional electric final control elements is integrated according to the present invention directly in the steering column unit, so that the latter is designed as a closed assembly unit per se, i.e., as an assembly unit containing all the components necessary for performing its function. Besides the technical advantages arising from this—complete configurability already at the manufacturer (outside vendor) as well as the simplification of the assembly—this takes into account the requirement concerning a defined demarcation of the system in an especially favorable manner. As will be explained later, only a connection to the onboard power supply system needs to be performed, depending on the particular application, during the installation of the steering column unit in a motor vehicle.

According to one embodiment of the present invention, the particular position of the steering column is determined by the electronic control unit during use in the course of its adjustment by the electronic control unit evaluating this relative movement relative to the normal position of the steering column. A signal generation (preferably increment formation in storage cells of the unit) corresponding to the movement of the steering column takes place for this purpose in the control unit, the movement of the steering column being detected by means of suitable sensors. To set the normal position of the steering column, limit switches are arranged at the mechanical components of the steering column in this embodiment and they are connected to the electronic control unit. Starting from the normal position—steering column in the rear position, i.e., withdrawn from the passenger compartment and at the top—an increment formation takes place in storage cells of the sensor unit preferably during each revolution or during every other revolution of the drive by means of which the steering column is moved in one direction or the other.

Since mechanical components, such as the adjusting spindle, are necessary for converting the electrically initiated movement, mechanical tolerances, which may lead to errors in increment formation, may become established during long years of the operation of the assembly unit. As a result, the position of the steering column may not be determined accurately by the control electronic system any longer in case of the accumulation of such tolerances over a longer period of time. To avoid this, a self-adjustment function is provided in an advantageous variant of the embodiment operating with a relative determination of the position of the steering column. The steering column is brought here cyclically into the normal position, but preferably only with the engine of the motor vehicle stopped, the calculation of the relative position is re-initialized, and the steering column is moved again into the position it had assumed before. “Increments that may have been lost” for the determination of the position can thus be corrected again. The conditions according to which this self-adjustment operation shall take place are stored as firmware in the electronic control unit, which is an integral part of the steering column unit according to the present invention. It is conceivable, for example, to perform such a self-adjustment each time after the key is removed from the ignition.

Another possibility of determining the position is the determination of the particular absolute position of the steering column. This is performed by evaluating the signals of transducers, preferably potentiometers, which are provided for this purpose in another embodiment of the present invention. Contrary to the relative determination, the absolute determination of the position is independent from tolerances of mechanical parts. A continuous adjustment can therefore be eliminated in this embodiment.

The range of adjustment of the steering column must, of course, be limited, especially also for the protection of the drive or drives used for the adjustment. This is preferably achieved by means of so-called software end stops, i.e., by means of the parameters that are stored in the control unit and are evaluated in a corresponding manner by the control unit during the adjustment operation. According to an especially advantageous embodiment, the software end stops are variably programmable, either by the manufacturer during the manufacturing process or by the vehicle manufacturer during the installation of the steering column unit in a motor vehicle, the programming of the range of adjustment being possible, of course, only within fixed absolute limits.

Depending on the intended purpose, the steering column according to the present invention may also be designed as an autarchically operating unit or as a unit that is to be connected in the onboard electronic system. In the first case, the steering column unit has, as was already mentioned above, only terminals for the power supply, besides terminals for an operating element. However, the functionality of the assembly unit can be markedly increased by the connection into the onboard electronic system and the replacement with other vehicle components. An advantageous embodiment of the steering column unit according to the present invention therefore also has terminals or an interface for connection to the data bus of the motor vehicle. In regard to the designs for the motor vehicle electronic system currently in use, the steering column unit preferably has an interface to the CAN (Controller Area Network) bus.

Due to the connection into the bus of the vehicle, it is also possible, among other things, to set the steering column unit in coordination with other vehicle components or to allow or block the adjustment of different conditions concerning the status of the vehicle. Corresponding to an especially advantageous variant, the electronic control unit of the assembly unit has, furthermore, a diagnostic function. In case of a disturbance or malfunction occurring in the assembly unit, an error code is stored in this case internally in memories of the control unit that are provided for this purpose, and the adjustment of the steering column is blocked if necessary. In case of the connection into the bus of the vehicle, an error message can be generated for the driver for better control and transmitted to a display in the motor vehicle via the data bus. Another advantageous embodiment of a steering column unit to be connected into the bus system has a key-IN/key-OUT function. Triggered by control signals of the electronic control unit when the key is inserted into the ignition (or when the ignition is activated by means of a key card or the like), the steering column now moves into a predetermined position for driving, which position is stored, e.g., in a memory of the control unit, whereas the steering column is moved into a position in which getting out and getting in are facilitated for the driver when the key is removed from the ignition (or the ignition is deactivated or the engine is shut off). The information on whether the ignition key has been inserted or removed is received by the control unit via the data bus of the motor vehicle, preferably in the form of a corresponding CAN signal.

In a likewise possible advantageous variant, a plurality of fixed positions for the steering column can be stored in the memory of the electronic control unit, and the steering column assumes this position based on a corresponding actuation of its electromechanical components by the control unit, triggered by the communication with other assembly units of the vehicle or by the actuation of operating elements by the user of the vehicle. Thus, it is possible, for example, that such a steering column position stored in the memory of the control unit is assumed corresponding to the automatic adjustment mechanism and a memory function of the vehicle seat, which memory function is provided in this connection.

The steering column unit may have separate drives for the longitudinal adjustment and the tilt adjustment. However, an embodiment with only one drive is to be preferred for cost reasons and to reduce the weight. The driving force of this drive is now transmitted, induced by control signals of the electronic control unit integrated within the assembly unit by means of electric final control elements, preferably electromagnets, to corresponding mechanical elements for adjusting the steering column either in the longitudinal direction and/or concerning its tilt [comma after “veranlasst” on p. 6, line 23 of the German original should be after “dabei”—Tr.Ed.].

The motor vehicle steering column unit according to the present invention affords a high level of flexibility concerning its adaptation to motor vehicle models and/or customer wishes, i.e., the wishes of the vehicle manufacturer using the unit. Due to the design as a practically independently fully functional unit, its use is also possible in motor vehicles which are not outfitted in advance for the installation of electromechanically adjustable steering columns of a conventional design, e.g., because of necessary end stages for actuating the drive or drives.

The present invention shall be explained in greater detail below on the basis of an exemplary embodiment. In the corresponding drawings,

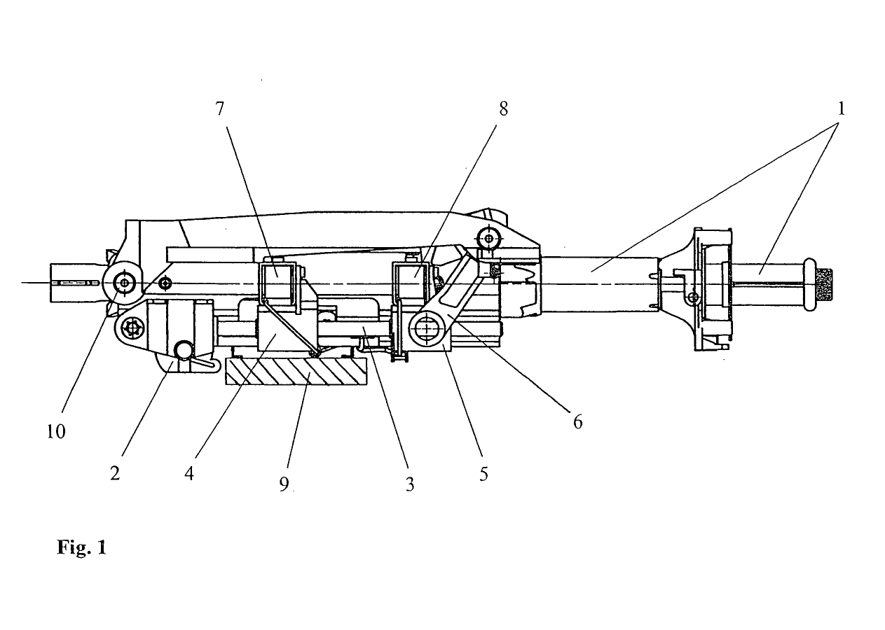

FIG. 1 shows a possible embodiment of the motor vehicle steering column according to the present invention;

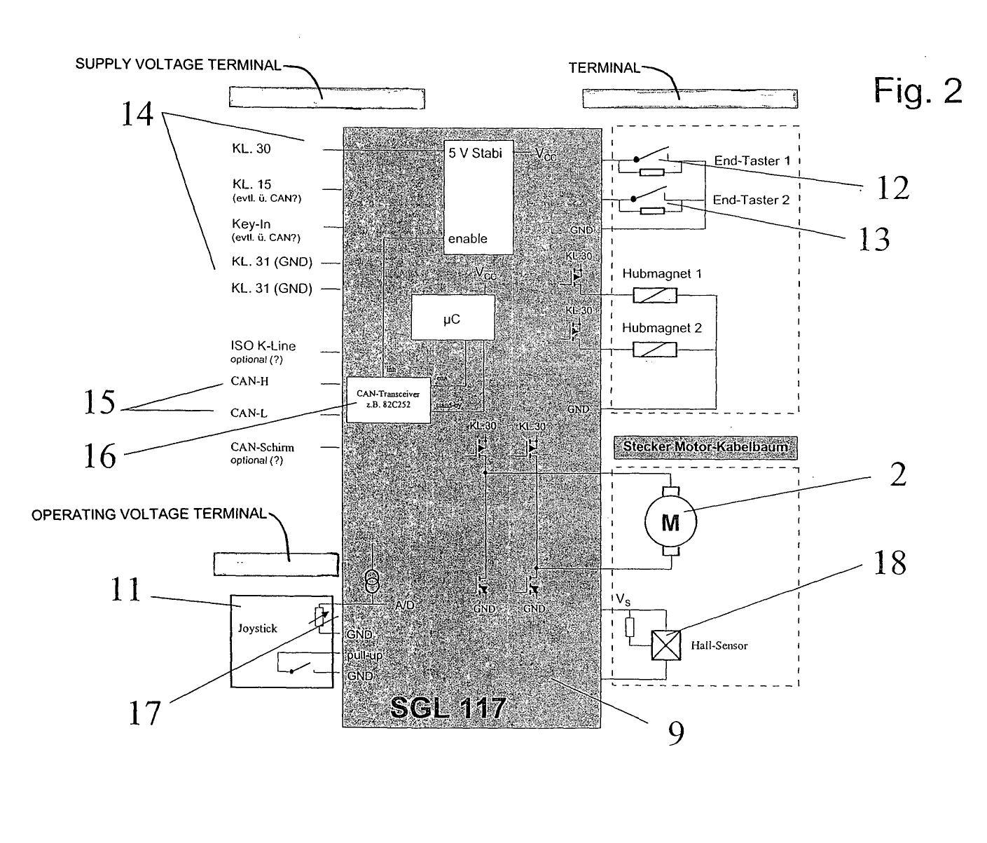

FIG. 2 shows a possible basic circuit diagram for the electronic control unit and its external connections,

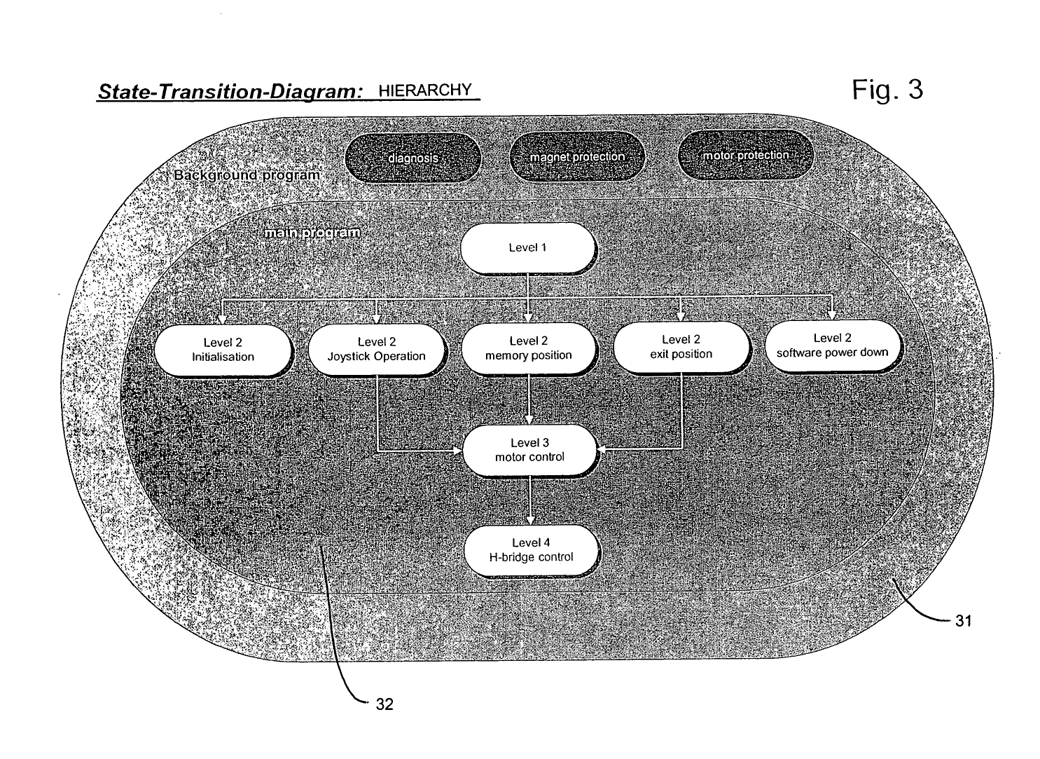

FIG. 3 shows a possible control diagram for adjusting the steering column and for providing additional functions using the control unit according to FIG. 2 in an automatic design;

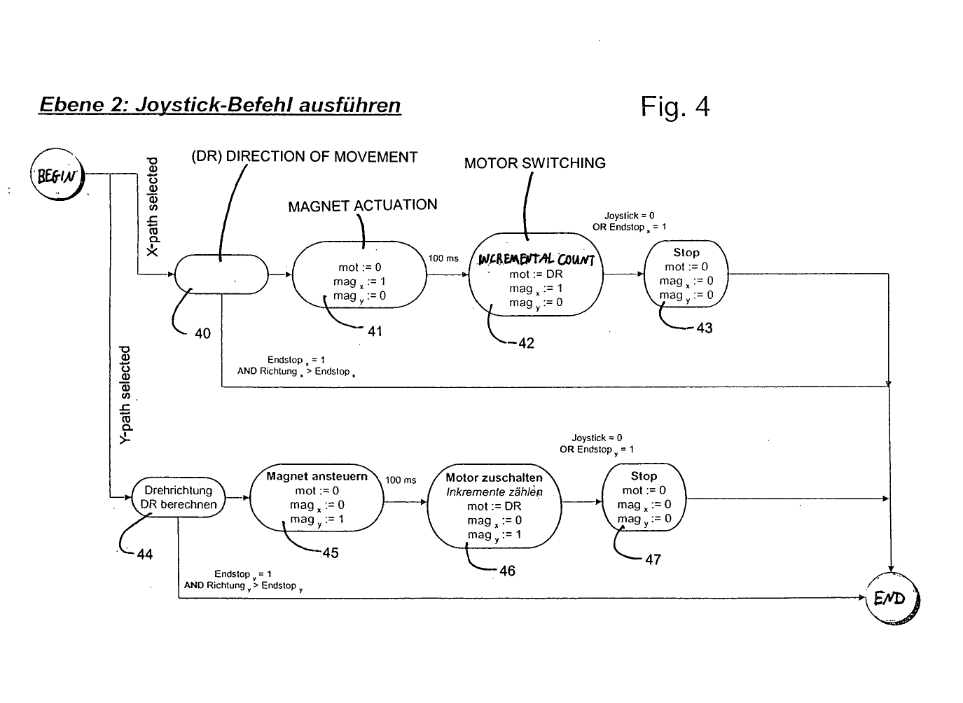

FIG. 4 shows a reduction of the state Joystick Operation according to FIG. 2, likewise in an automatic design; and

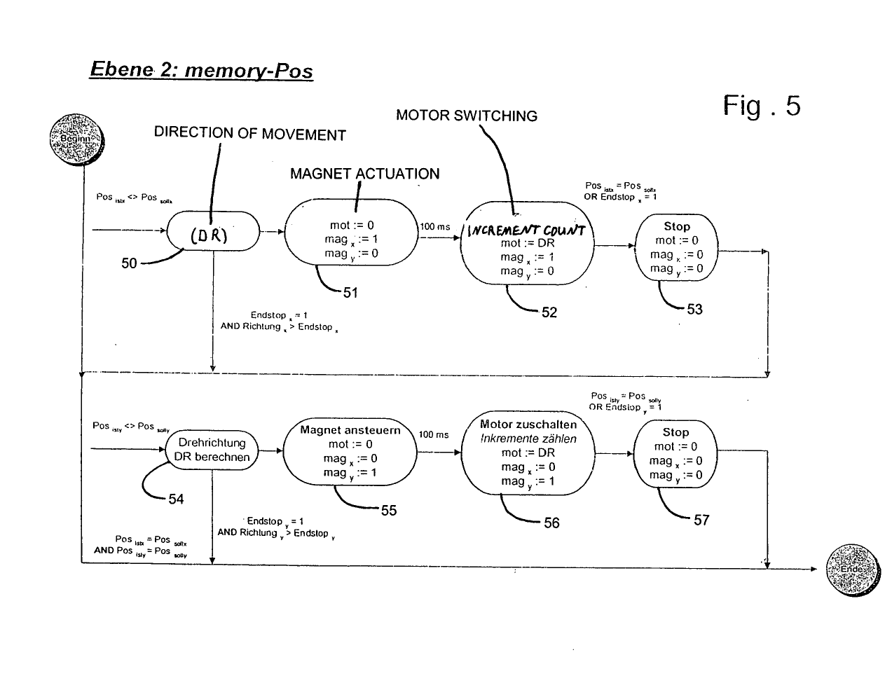

FIG. 5 shows a reduction of the state Memory Position according to FIG. 2 in the automatic design.

FIG. 1 shows a basic embodiment of the motor vehicle steering column unit according to the present invention. The steering column unit comprises essentially the steering column 1, the drive 2 for rotating the adjusting spindle 3, the spindle nuts 4, 5 running on the adjusting spindle 3, the pivoted lever 6, which converts the movement of the spindle nut 5 into an upward and downward movement and a pivoting movement of the steering column, the final control elements or electromagnets 7, 8, and the electronic control unit 9, which, as can be recognized, is an integral part of the assembly unit. When an operating element 11 arranged in the vehicle, which is shown in FIG. 2, is actuated, the drive 2 and the final control elements 7, 8 are actuated by the electronic control unit 9. Either the spindle nut 4 or 5 or both spindle nuts 4, 5 are fixed by means of a non-positive connection established by the electromagnets 7, 8 in case of a corresponding actuation by displacing a pin (not shown here), so that the steering column 1 moves axially (in the longitudinal direction) and/or in terms of its tilt angle during the simultaneous rotary movement of the adjusting spindle 3. While the actuation of the electromagnet 7 brings about an axial movement of the steering column 1, the tilt of the steering column is changed by pivoting around the fulcrum point 10 during the actuation of the electromagnet 8. At the time of installation in a vehicle, the steering column unit needs only be connected to the onboard power supply system, an operating element 11 and optionally to the bus of the vehicle by means of terminals 14, 15, 17 (shown in FIG. 2) arranged preferably at the electronic control unit 9 to establish its electric/electronic readiness to operate, and the operating element 11 may also be arranged directly on a cover (not shown here) of the assembly unit. The decentralized conversion of the actuating signals of the operating element 11 or the adjusting signals of other units of the vehicle by the electronic control unit 9 integrated within the steering column unit into control signals for the drive 2 and the final control elements 7, 8 is essential for the present invention.

FIG. 2 shows a possible basic circuit diagram of an electronic control unit 9 to be connected into the CAN bus of a motor vehicle with the corresponding external connections for one embodiment of the present invention with relative position determination of the steering column 1. The drive 2 used to actuate the adjusting spindle 3 is actuated by the control circuit. An incremental transducer wheel on the motor shaft of the drive 2 is scanned by means of a Hall sensor 18 for detecting a movement of the steering column for determining the position of the steering column. The normal position of the steering column 1, which is used as a reference point for the determination of the position, is determined by the end stops 12, 13 (end switch 1, end switch 2). The adjustment of the steering column 1 is performed by means of operating elements II (switching rocker or the like, designated by a joystick in the figure) connected to the electronic control unit 9. Besides terminals 14 for the supply voltage, contacts (terminals) 15 are provided for connection to the CAN data bus. The data exchange with the CAN bus takes place via the so-called CAN transceiver 16.

FIGS. 3 through 5 shows examples of control operations for carrying out different functions of the assembly unit in an automatic design. FIG. 3 pertains to the basic control diagram with exemplary functions. Embedded in a background program, which makes available, among other things, diagnostic functions and protective functions for the drive or drives and is permanently active in the background, the main program runs with the ignition turned on. The different functions are shown in the view as a hierarchic status graph. The functions Initialization, Joystick Operation, Memory Position, Exit Position as well as Software Power Down are embodied in level 2 below level 1, the global control. The two functions Joystick Operation and Memory Position shall be discussed in greater detail below in connection with the explanation to FIGS. 4 and 5.

The function Joystick Operation (actuation of a switching rocker or a similar operating element to adjust the steering column 1 by the user) is reduced in FIG. 4 concerning its process by an automatic status mechanism. In case of actuation of the operating element 11 intended for adjusting the steering column 1, the control unit 9 first determines whether an adjustment in the longitudinal direction and/or concerning the tilt shall take place. Branching will correspondingly be performed into the branch “x path selected” in case of a longitudinal adjustment or into the branch “y path selected” in case of an adjustment of the tilt. The calculation of the direction of movement DR (direction of rotation for drive 2) is then performed. The magnet 7 or 8 intended for the conversion of the driving force for the desired adjustment (adjustment in the longitudinal direction or in terms of tilt) is subsequently actuated. The assignment magₓ: =1 symbolizes the actuation of the magnet 7 converting the driving force into a longitudinal movement. Unless an adjustment of the tilt shall also be performed, the other electric final control element (electromagnet) 8 mag_{y} is consequently set to zero. The drive 2 itself is not yet actuated in this status position. It remains switched off for t he time being (mot: =0). The drive 2 is put into action (mot: =DR) only after the actuation of the corresponding electromagnet 7 or 8 and its revolutions are counted by the electronic control unit 9 by increment formation.

When a corresponding condition occurs (the joystick 11 is either not actuated any more or it has reached the maximum adjusted position), the status Stop is assumed, in which the drive 2 is again switched off and the electromagnets 7, 8 are not actuated any longer.

FIG. 5 shows the assumption of a position of the steering column I stored in the control unit 9 or preset by other assembly units of the vehicle (e.g., driver's seat) (memory position) in a form comparable to that in FIG. 4. The control unit 9 first determines in this case as well whether the displacement of the steering column 1 into the predetermined position requires the movement of the steering column in the longitudinal direction and/or in relation to its tilt. The electromagnets 7, 8 are subsequently actuated in a corresponding manner and the drive 2 is actuated thereafter. The break-off condition for the movement is the reaching of the desired position (Pos_{actual x}=Pos_{desired x} or Pos_{desired y}=Pos_{desired y}) or of the end stop.

List of Reference Numbers:

1 Steering column

2 Drive

3 Adjusting spindle

4 Spindle nut

5 Spindle nut

6 (Pivoted) lever

7 (Electric) final control element, electromagnet

8 (Electric) final control element, electromagnet

9 Electronic control unit

10 Fulcrum point

11 Operating element, joystick or switching rocker

12 (End) stop

13 (End) stop

14 Terminals for power supply

15 Bus terminal

16 Can transceiver

17 Terminals for operating element

18 Hall sensor

1. Motor vehicle steering column unit, whose said steering column (1) is electromechanically adjustable in the longitudinal direction and/or in terms of its tilt angle and which comprises as an assembly unit that is closed per se at least one said drive (2), a said electronic control unit (9) for generating control signals for the said drive or drives (2) and said electric final control elements (7, 8) as well as said terminals (14, 15, 17) for connection to a said operating element (11) and to the onboard power supply system, besides the said mechanical elements (3, 4, 5, 6) and said final control elements (7, 8) necessary for actuating the steering as well as for the electrically initiated changing of the position of the said steering column (1).

2. Motor vehicle steering column unit in accordance with claim 1, characterized in that the particular position of the said steering column (1) is determined by the said electronic control unit (9) by means of an evaluation of the relative movement of the said steering column relative to its normal position, and a signal corresponding to the movement of the said steering column, which movement is detected by sensors, is formed in the said electronic control unit (9) to evaluate the relative movement.

3. Motor vehicle steering column unit in accordance with claim 2, characterized in that said end stops (12, 13) connected to the said electronic control unit (9) are provided on the mechanical components of the said steering column (1) to set a normal position of the said steering column (1).

4. Motor vehicle steering column unit in accordance with claim 2 or 3, characterized in that the assembly unit has a self-adjustment function, by means of which the control unit avoids a possible incorrect calculation of the relative position of the said steering column (1) in the case of accumulating mechanical tolerances by the said steering column (1) moving, initiated by the said electronic control unit (9), cyclically into the normal position, preferably with the engine of the motor vehicle shut off, and the calculation of the relative position is re-initialized and the said steering column (1) is again moved into its previously assumed position.

5. Motor vehicle steering column unit in accordance with claim 1, characterized in that an absolute determination of the particular position of the said steering column (1) is performed by means of the said electronic control unit (9) by the evaluation of the signals of transducers provided for this purpose, preferably potentiometers.

6. Motor vehicle steering column unit in accordance with claim 2 or 5, characterized in that software end stops, which are embodied by control signals generated by the said electronic control unit (9) corresponding to break-off criteria stored in it for the adjustment of the said steering column (1), are provided for limiting the range of adjustment concerning the longitudinal displacement and the tilt of the said steering column (1).

7. Motor vehicle steering column unit in accordance with claim 6, characterized in that the software end stops can be programmed by means of operating elements provided for this purpose and can be set variably as a result in adaptation to the vehicle model or to preset values of the motor vehicle manufacturer.

8. Motor vehicle steering column unit in accordance with claim 2 or 5, characterized in that the assembly unit or its said electronic control unit (9) comprises only said terminals (14) for the power supply besides said terminals (17) for the said operating element (11) and is otherwise autarchic in relation to the onboard electrical or electronic system.

9. Motor vehicle steering column unit in accordance with claim 2 or 5, characterized in that the assembly unit has said terminals for the power supply (14) and (15) for connection to the data bus of a motor vehicle, besides said terminals (17) for a said operating element (11).

10. Motor vehicle steering column unit in accordance with claim 9, characterized in that the assembly unit has terminals for connection into the CAN (Controller Area Network) bus of a motor vehicle.

11. Motor vehicle steering column unit in accordance with claim 9 or 10, characterized in that the said electronic control unit (9) has a diagnostic function, by means of which a corresponding error code is stored internally, the adjustment of the said steering column (1) is blocked and/or an error message is generated and, if the assembly unit is connected into the bus of the vehicle, it is sent to a display of the motor vehicle in the case of a disturbance or malfunction occurring in the assembly unit.

12. Motor vehicle steering column unit in accordance with one of the claims 1 through 11, characterized in that fixed positions for the said steering column (1), which the said steering column (1) assumes based on the communication with other assembly units of the vehicle or upon the actuation of said operating elements (11) by a user of the vehicle, triggered by control signals generated by the said control unit (9) and sent to the said drive (2) and to said electric final control elements (7, 8), can be stored in a memory of the said electronic control unit (9).

13. Motor vehicle steering column unit in accordance with one of the claims 9 through 11, characterized in that the assembly unit has a key-in/key-out function, by means of which the said steering column (1) moves, triggered by control signals of the said electronic control unit (9) when the key is inserted into the ignition, into a preset position or a position stored in the memory of the said control unit (9) and into a position that facilitates getting out and getting in for the driver when the key is removed from the ignition, wherein the said electronic control unit (9) receives information on whether the key has been inserted or removed via the data bus of the motor vehicles.

14. Motor vehicle in accordance with unit in accordance with one of the claims 1 through 12, characterized in that both the adjustment of the said steering column (1) in the longitudinal direction and the adjustment of its tilt are performed by means of one and the same said electric drive (2), whose driving force is transmitted, triggered by the control signals of the said electronic control unit (9) integrated within the assembly unit, to said mechanical elements (4, 5, 6) for adjusting the said steering column (1) in the longitudinal direction and/or in terms of its tilt by means of said electric final control elements (7, 8), preferably electromagnets.
